(19) United States
(12) Patent Application Publication
(10) Pub. No.: US 2016/0119661 A1
(43) Pub. Date: Apr. 28, 2016

(54) On-Demand Metadata Insertion into Single-Stream Content

(71) Applicant: Adobe Systems Incorporated, San Jose, CA (US)

(72) Inventors: Venkata R. Jonnadula, San Jose, CA (US); Mason S. Wolf, San Jose, CA (US); Srinath R. Joshi, Sunnyvale, CA (US); Maresa Nirwan, San Leandro, CA (US); Jesus Armando Figueroa Salido, San Jose, CA (US); Richard N. Wisher, San Jose, CA (US)

(21) Appl. No.: 14/522,459

(22) Filed: Oct. 23, 2014

(51) Int. Cl. H04N 21/236; H04N 21/44; H04N 21/435; H04N 21/235; H04N 21/81

(52) U.S. Cl. CPC H04N 21/23611; H04N 21/235; H04N 21/812; H04N 21/435; H04N 21/44016

(57) ABSTRACT

Techniques for on-demand metadata insertion into single-stream content are described. In one or more implementations, media content is obtained responsive to a request. The media content can be included in a content stream that also includes alternate content that is spliced into the content stream. Metadata is injected into the content stream at runtime in association with a starting point of the alternate content. The metadata can enable a media player to identify the alternate content and a location of the alternate content within the content stream. The content stream is then transmitted as a single stream to the media player for playback of both the media content and the alternate content.

### BACKGROUND

Conventionally, two separate video players are used to playback video and advertisements. For example, a first video player may render the video onto a device, and a second video player may be overlaid on top of the first video player to display advertisements or commercials. When playback of the advertisements is completed, the second video player is removed from the screen, revealing the underlying video displayed via the first video player.

In these conventional techniques, however, the multiple video players may compete for bandwidth since the video players are loading different pieces of content at the same time. Additionally, transitions between video to advertisement and advertisement to video may not be seamless. Moreover, advertisement blocking software may be used to block the second video player from displaying the advertisement, which can result in monetary loss and a lost advertising opportunity. Thus, conventional techniques for media playback have deficiencies that may cause user or provider dissatisfaction in some scenarios.

### SUMMARY

Techniques for on-demand metadata insertion into single-stream content are described. In one or more implementations, media content is obtained responsive to a request. The media content can be included in a content stream that also includes alternate content that is spliced into the content stream. Metadata is injected into the content stream at runtime in association with a starting point of the alternate content. In at least some implementations, the metadata can enable a media player to identify the alternate content and a location of the alternate content within the content stream. The content stream is then transmitted as a single stream to the media player for playback of both the media content and the alternate content.

In at least one implementation, a request for content to be delivered via a single stream of content is received. Advertisement locations are identified that correspond to one or more advertisements included in the single stream of content. Metadata is embedded into the single stream of content at runtime based on the request. In implementations, the metadata can be associated with advertisements to enable a client device to identify the advertisements and ascertain when the advertisements begin playback within the stream of content based on the advertisement locations.

In some implementations, a request for media content is transmitted to a media source. A single content stream is then received that includes the requested media content, additional media content that was spliced in to the single content stream, and metadata associated with the additional media content. The content stream can then be processed to playback the media content and the additional media content. In response to encountering the metadata during the processing of the content stream, the metadata is parsed to identify the additional media content and ascertain when the additional media content begins playback. Then, the metadata is used to track the additional media content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques for on-demand metadata insertion into single-stream content.

FIG. 2 is a flow diagram depicting a procedure in an example implementation in which techniques for on-demand metadata insertion into single-stream content are employed.

FIG. 3 is a flow diagram depicting a procedure in an example implementation for processing single-stream content with in-stream metadata.

FIG. 4 illustrates various components of an example device that can be implemented as any type of computing device as described with reference to FIG. 1 to implement the techniques described herein.

### DETAILED DESCRIPTION

Overview

Conventional techniques used to playback streaming video content and advertisements can be inefficient. For example, the use of two separate video players for the playback of video content and advertisements can result in bandwidth competition, blocked advertisements, and/or difficulties in tracking advertisement playback.

Video content and advertisements can be streamed to a client via a single content stream by inserting the advertisements into the content stream. However, conventional techniques that were used to playback streaming video that includes inserted advertisements cannot track whether and/or when those advertisements were actually displayed. These and other deficiencies can prevent advertisers from gathering important feedback associated with their advertisements.

Techniques involving on-demand metadata insertion into single stream content are described. Implementations are described that involve inserting metadata into the single stream to enable a client device to identify and track the alternate content within the single stream. For example, a media content service can receive a request from a media player for a specific video stream. The request can contain information to enable a publisher to select one or more advertisements (e.g., “ads”) to include in the video stream. The media content service can send the information to an ad server that selects and returns the ads that are to be included in the video stream. In implementations, the ad server can return the ads using a variety of different standards such as for example, Video Ad Serving Template (VAST) standard.

A response to the video player can then be sent that includes a list of ads that can potentially be played, and one or more tracking uniform resource locators (URLs) that are associated with the ads. In at least some implementations, one or more companion ads, such as a banner ad, can be included in the response to the video player such that the companion ad can be presented to the viewer at the same moment an in-video ad is played.

In implementations, if a transcoded ad cannot be located or is not fully transcoded, the media content service can initiate an application programming interface (API) call to a transcoding service to inject a metadata packet, such as an ID3 metadata packet, into an original version of the ad. In some implementations, if the metadata packet is not currently available, then the metadata packet can be generated at runtime. In one example, the metadata packet includes a distinct key which the video player can recognize. The metadata packet can also contain information associated with the ad, such as an identifier (ID) for the ad, an ad system, and optionally a creative ID. In at least one implementation, the information in the metadata packet includes a duration of the ad to identify an amount of time that is to be consumed for playback of the ad.

Once the metadata packet is injected into the ad, the ad can be placed on a content delivery network (CDN) and a callback URL ping can cause the lookup table to be updated to identify the ad's availability to be used based on subsequent ad requests. In some implementations, the processing time to inject the metadata packet into the ad and/or to transcode the ad can be lengthy, thereby causing delays in transmitting the video stream. To avoid these potential delays, the media content service can select an alternate ad, if one is available, to serve with the requested video stream while the ad is being transcoded and/or while the metadata packet is being injected into the ad.

When the video player begins playback of the ad, the video player can detect the metadata packet, such as by detecting an ID3 metadata packet including a timestamp. The metadata packet can contain the information associated with the ad being played back. Subsequently, the video player can use the information to perform various operations associated with the ad, such as synchronizing an ad tracking operation frame by frame. In some implementations, a ping to a progress tracking URL can fire at the correct moment given the progress of the video stream. Further, based on the ad been played, a companion ad may also be presented to the viewer at the appropriate time.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

As employed herein, the term “media content” is representative of electronic data, such as text content (e.g., messages), digital photographs, video, audio, audio/video data, and so on. Some examples include streaming video, such as movies, television shows, music videos, video clips, and so on. Alternate content can include video data that is independent of the media content, such as advertisements or commercials. The content can be displayed for the user, and can be selectable by the user to perform one or more actions. Further examples of the above-described terms may be found in relation to the following discussion.

As employed herein, the term “media player” is representative of a functionality to process and display digital media, such as audio, video, or animation files. The media player can also be referred to as a video player, and can be implemented by a software application. Other examples include a media player device, such as a digital versatile disc (DVD) player, Blu-ray player, and so on, that is configured to connect to a television to cause the television to display the digital media. Accordingly, the media player can be implemented in a variety of ways to process and display media content.

Example Environment

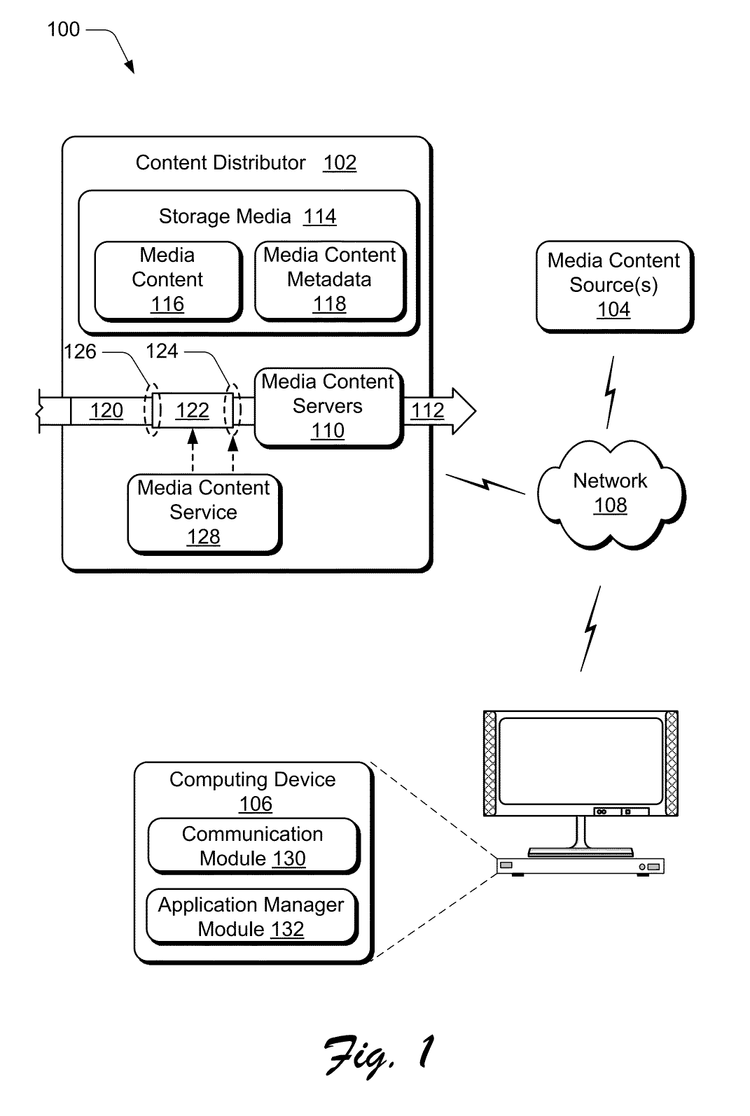

FIG. 1 is an illustration of an environment 100 in an example implementation that is operable to employ techniques described herein. The illustrated environment 100 includes one or more content distributors 102 and/or other media content sources 104 that communicate or otherwise provide media content to any number of various media devices, such as a computing device 106, via a network 108. The various media devices can include wireless media devices or other wired and/or wireless client devices. In a media content distribution system, the content distributors 102 facilitate the distribution of media content, content metadata, and/or other associated data to multiple viewers, users, viewing systems, and devices.

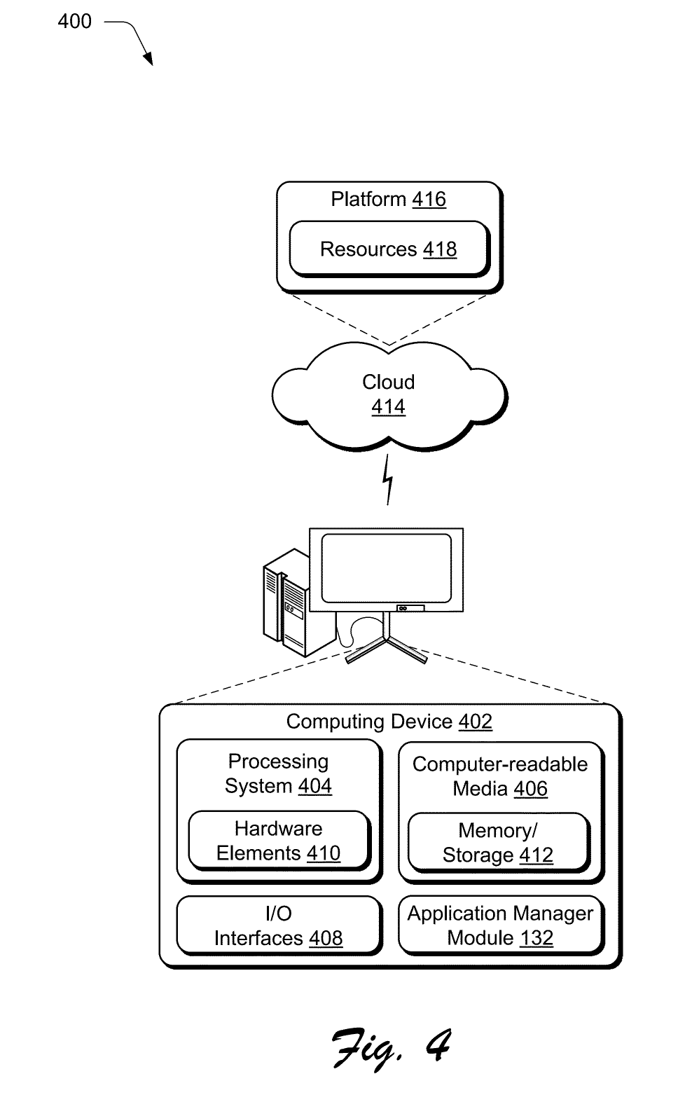

In addition, the computing device 106 as well as computing devices that implement the content distributor 102 and the media content sources 104 may be configured in a variety of ways. The computing devices, for example, may be configured as a desktop computer, a laptop computer, a mobile device (e.g., assuming a handheld configuration such as a tablet or mobile phone), and so forth. Thus, the computing devices may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers of the content distributor 102 utilized by a business to perform operations “over the cloud” as further described in relation to FIG. 4.

Although the network 108 is illustrated as the Internet, the network may assume a wide variety of configurations. For example, the network 108 may include any type of data network, voice network, broadcast network, an IP-based network, a wide area network (WAN), a local area network (LAN), a wireless network, a public telephone network, an intranet, and so on. Further, although a single network 108 is shown, the network 108 may be representative of multiple networks. The network 108 can be implemented to facilitate media content distribution and data communication between the content distributors 102 and any number of various computing devices 106.

The content distributor 102 can include one or more media content servers 110 that are implemented to communicate, or otherwise distribute, media content and/or other data to the computing device 106. The media content servers 110 can receive video feeds of video content, such as television media content, for distribution to media devices. In this example system 100, the content distributor 102 includes storage media 114 to store or otherwise maintain various media content 116 and/or data, such as media content metadata 118. The storage media 114 can be implemented as any type of memory and/or suitable electronic data storage.

The media content 116 can include any type of audio, video, and/or image data received from any type of media content source or data source. As described throughout, media content 116 can include music (e.g., digital music files of songs), television programming, movies, on-demand media, interactive games, network-based applications, and any other audio, video, and/or image data (e.g., to include program guide data, user interface data, advertising content, closed captions data, content metadata, search results and/or recommendations, etc.). Media content 116 can include various display formats of the media content, such as a highest quality display format (e.g., a highest quality, high-definition display format, hyper-definition display format, or IMAX experience display format) to a lower quality display format (e.g., a lower quality, standard-definition display format), and any other quality of display format along a continuum between the two.

The media content metadata 118 can include any type of identifying criteria, descriptive information, and/or attributes associated with the media content 116 that describes and/or categorizes the media content 116. For example, metadata can include a media content identifier, title, subject description, a date of production, artistic information, music compilations, and any other types of descriptive information about a particular media content. Further, metadata can characterize a genre that describes media content, such as video content, as being an advertisement, a movie, a comedy show, a sporting event, a news program, a sitcom, a talk show, an action/adventure program, or as any number of other category descriptions. Additionally, metadata can indicate locations of alternate content within a stream of the media content 116, such as locations corresponding to starting and/or ending points of one or more advertisements within the stream. In addition, metadata can include a link to a website or other merchant site that sells products and/or services associated with the advertisement. In some implementations, the metadata can include a companion ad, such as a banner ad, which is displayable in conjunction with another advertisement.

The media content servers 110 at content distributor 102 can receive the content stream 112 of media content 116 that includes the requested content and alternate content, such as one or more advertisements. The content stream 112, such as a video feed or video stream, can include multiple segments of the media content 116, such as television programming (for one or more television programs), interspersed or separated by multiple advertisement pods, each having one or more advertisements or commercials for various products and/or services. In this example, the content stream 112 includes advertisements 120 and 122. Advertisement 120 is an example of an advertisement that was included as part of the originally distributed content stream 112, and advertisement 122 is an example of an advertisement that has been spliced into the content stream 112 between splice points 124 and 126, which indicate starting and ending points, respectively, of the advertisement 122 within the content stream 112. The spliced-in advertisement 122 can be spliced into the content stream 112 by a publisher or broadcaster of the content stream, a third party, or by a media content service 128 at the content distributor 102.

In one or more implementations, the content distributor 102 can be implemented as a subscription-based service from which any of the computing devices 106 can request media content 116 to download and display for viewing. The media content service 128 can be implemented to manage the media content 116 that is to be distributed to the computing devices 106. For example, the media content service 128 can receive a request for the media content 116 from the computing device 106, and splice or otherwise insert ads, if needed, into the content stream 112 for distribution to the computing device 106.

Additionally, the media content service 128 is representative of functionality to embed the media content metadata 118 into the content stream 112. In implementations, the media content service 128 can dynamically embed the media content metadata 118 in response to the request from the computing device 106 for the media content 116. For example, the media content service 128 can utilize the splice points 124 and/or 126 as locations within the content stream 112 to embed the media content metadata 118 associated with the advertisement 122. Metadata can be embedded in a variety of formats and/or standards. For example, an ID3 tag is a type of metadata container that can be used to store information about a file, such as an MP3 or MP4 file, within the file itself. Any of a variety of container-based formats can be utilized to embed the metadata into the file.

In one or more implementations, a client media device such as computing device 106 that receives the content stream 112 can encounter the embedded media content metadata 118 at or near a starting point of the advertisement 122. The computing device 106 can then parse the media content metadata 118 to identify the advertisement 122 as well as to identify when the advertisement 122 begins and/or ends playback within the content stream 112. Without the metadata 118, the computing device 106 may not be capable of performing operations associated with the advertisement 122, such as identifying and/or tracking the advertisement 122, modifying a browser interface used to display the ad, displaying a companion ad in conjunction with the ad at a correct moment to synchronize display of the companion ad with the display of the ad, and so on.

In one or more implementations, the media content service 128 can be implemented to splice the alternate content into the content stream 112 thereby creating splice points, such as the splice points 124 and 126, which indicate a starting and/or ending point of the alternate content. For example, when a media player or server requests that alternate content be spliced into the content stream 112, the media content service 128 can be implemented to analyze at runtime whether the alternate content includes metadata, and if not, then the metadata can be injected into the content stream 112 in association with the alternate content being spliced into the content stream 112. Alternatively or additionally, the alternate content can be included in the content stream 112 when the media content service 128 receives the content stream 112 from a source of the content.

The computing device 106 is also illustrated as including a communication module 130 and an application manager module 132. The communication module 130 is representative of functionality to communicate via the network 108, such as with one or more services of the content distributor 102 or the one or more media content sources 104. As such, the communication module 130 may be configured in a variety of ways. For example, the communication module 130 may be configured as a browser that is configured to “surf the web.” The communication module 130 may also be representative of network access functionality that may be incorporated as part of an application, e.g., to provide network-based functionality as part of the application, an operating system, and so on. Thus, functionality represented by the communication module 130 may be incorporated by the computing device 106 in a variety of different ways.

The application manager module 132 is representative of functionality to manage an application on the computing device 106. As such, the application manager module 132 may be configured in a variety of ways. For example, the application manager module 132 may be configured to process a stream of media content 116, such as the content stream 112 received from the content distributor 102, and display the media content 116 via a browser interface. In implementations, the application manager module 132 can detect the media content metadata 118 embedded in the content stream 112, and can use the detected media content metadata 118 to perform one or more operations. For example, the application manager module 132 can use the media content metadata 118 to identify the advertisements 120 and 122 and when the advertisements 120 and 122 begin playback within the content stream 112. Additionally, the application manager module 132 can utilize the media content metadata 118 to track the advertisements 120 and 122. In an example implementation, the media content metadata 118 can include a link to a merchant site that sells products or services associated with one or more of the advertisements 120 and 122. In one or more implementations, the application manager module 132 can utilize information in the media content metadata 118 to modify the browser interface to display of the ad.

In some implementations, the application manager module 132 can be configured to implement a media player configured to playback the media content 116 from the content stream 112. For example, a single media player can be implemented to playback both the requested content and the alternate content via a single stream of content.

In contrast to conventional techniques, the application manager module 132 implements a single media player to playback both the media content and the advertisements in the stream. Consequently, transitions between the media content 116 and the advertisements are seamless because the single media player is processing a single stream of content. As described above, the single media player can encounter the media content metadata 118 within the stream, and use the media content metadata 118 to identify or otherwise track the advertisements. The computing device 106 can then provide feedback to the media content service 132 to pass on to advertisers and publishers regarding playback of the ads. The advertisers and publishers can then use the feedback to determine monetary costs owed to content owners and publishers by the advertisers for particular ads that were displayed by the computing device 106.

Having described example operating environments in which the inventive principles can be employed, consider now a discussion of various methods.

Example Procedures

The following discussion describes techniques for on-demand metadata insertion into single-stream content that may be implemented utilizing the previously described systems and devices. Aspects of each of the procedures may be implemented in hardware, firmware, or software, or a combination thereof The procedures are shown as a set of blocks that specify operations performed by one or more devices and are not necessarily limited to the orders shown for performing the operations by the respective blocks. In portions of the following discussion, reference will be made to the environment 100 of FIG. 1.

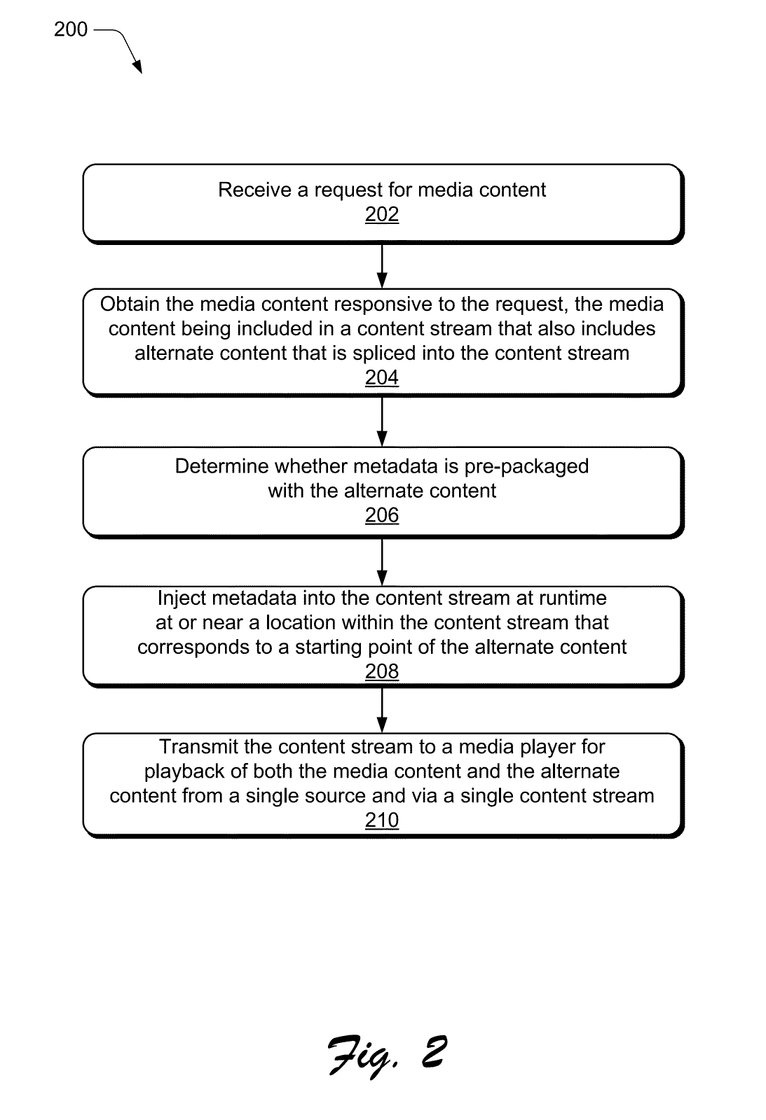

FIG. 2 is a flow diagram depicting a procedure 200 in an example implementation in which techniques for on-demand metadata insertion into single-stream content are employed. A request for media content is received (block 202). For example, the request can be received from a client device or server. Additionally, the request can indicate specific media content to be delivered to a requesting entity. For example, a user can request television programming to be streamed to a video player application at a client device associated with the user. Alternatively, a server can request television programming to be streamed to the server to enable the server to route the stream to a video player. As discussed above, the media content can include any of a variety of content such as for example, television programming, movies, video data, audio data, audio/video data, closed captioning, ticker tape, real-time text, and so on.

The media content is obtained responsive to the request, the media content being included in a content stream that also includes alternate content that is spliced into the content stream (block 204). For example, the content distributor can be implemented to obtain the media content from a media source or other database. The obtained media content can include alternate content that has been spliced into the content stream for transmitting to the requesting entity. In some example implementations, the alternate content can include any of a variety of media content, such as one or more ads or other video or audio data. In one or more approaches, the media content service 128 at the content distributor 102 can be implemented to splice the alternate content into the content stream 112 such that when the content stream 112 is transmitted to the requesting entity, both the media content and the alternate content are transmitted to the requesting entity via a single content stream.

In implementations, the media content service 128 can send information from the request to an ad server. The ad server can be implemented to use the information to select one or more ads that can be played with the media content. The ad server can then send a list of selected ads to the media content service 128. In addition, the ad server can send one or more tracking URLs that are associated with the selected ads, and any companion ads such as banner ads that are to be presented to a viewer at a substantially same moment that an associated in-video advertisement is displayed.

A determination is made whether metadata is pre-packaged with the alternate content (block 206). In one or more implementations, a source of the alternate content, such as the ad server, can include pre-packaged metadata associated with an advertisement when the ad server sends the advertisement to the media content service 128. For example, the media content service 128 can use a URL of each selected advertisement as a key into a lookup table to determine whether a version of a respective advertisement currently exists that contains associated metadata usable by the media player to track the respective advertisement. If such a version of the respective advertisement does exist, then the media content service 128 can use the existing version, such as a transcoded version, of the advertisement, rather than using another version of the advertisement sent by the ad server to the media content service 128 based on the information. Alternatively, if no such version of the respective advertisement is located by using the lookup table, then the other version of the advertisement sent by the ad server to the media content service 128 can be transcoded.

In at least some implementations, the transcoded version of the advertisement may not yet be generated. If no transcoded version of the advertisement is located by using the lookup table, then the media content service 128 can initiate an API call to a transcoding service that can inject a metadata packet into an original file of the advertisement.

Metadata is injected into the content stream at runtime at or near a location within the content stream that corresponds to a starting point of the alternate content (block 208). For example, the media content service 128 at the content distributor 102 can be implemented to identify locations within the content stream 112 where the alternate content, such as advertisements 120 and 122, begin and/or end. In one or more implementations, those locations can be identified by locating corresponding splice points where the advertisement was spliced into the content stream. In at least some implementations, the metadata can be generated, such as at runtime and/or in response to the request. The metadata can then be embedded at or near those corresponding splice points. The metadata can include information identifying associated alternate content in the content stream. For example, the metadata can identify one or more objects in the alternate content, a merchant and/or merchant site that sells products or services associated with the alternate content, a timestamp of when the alternate content begins and/or ends playback within the content stream, an amount of time that the alternate content consumes when played back, and so on. Accordingly, the metadata can include any of a variety of information associated with the alternate content.

The content stream is transmitted to a media player for playback of both the media content and the alternate content from a single source and via a single content stream (block 210). For example, the content stream, which includes both the media content and the spliced-in alternate content, is transmitted to a media player for playback. In at least some implementations, the media player can play back both the media content and the alternate content via a single stream and from a single source. In this way, an application such as an advertisement blocker, cannot be used by the receiving entity to block the alternate content without causing the media player to have a blank or black screen. Instead, the media player can continue displaying the content in the content stream as the content is received, including the alternate content.

Further, because the metadata was injected into the content stream, the media player can identify the alternate content, and provide feedback associated with the alternate content to the content distributor or other source of the alternate content. The feedback can include identification of the alternate content, an indication of when the alternate content played back, whether user input was received in association with the alternate content (e.g., navigation to an associated merchant site), and so on. The source of the alternate content can use the feedback to confirm that the alternate content was indeed played back by that particular media player, and that the alternate content was likely viewed by a user of the media player.

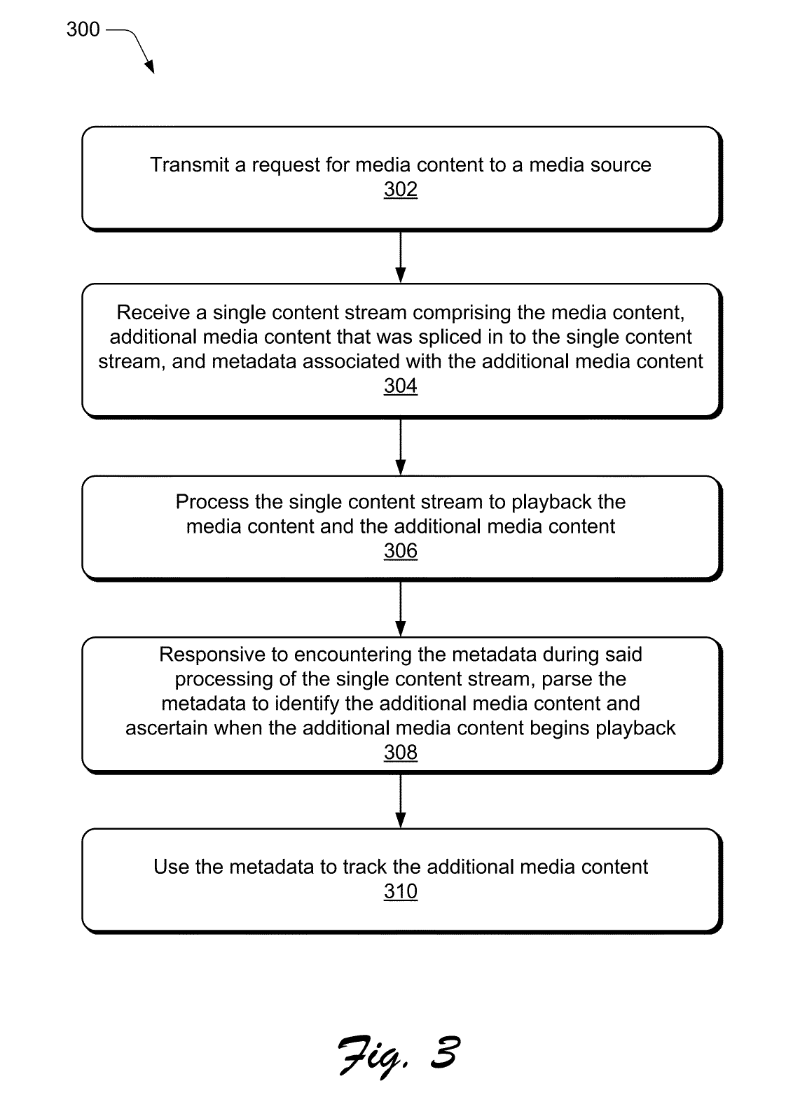

FIG. 3 is a flow diagram depicting a procedure 300 in an example implementation for processing single-stream content with in-stream metadata. A request for media content is transmitted to a media source (block 302). For example, a client device can send a request for particular media content, such as television programming, to a content distributor.

A single content stream is received that includes the media content, additional media content that was spliced into the single content stream, and metadata associated with the additional media content (block 304). For example, a media player application at the client device 106 can receive a stream of content for download. The stream of content is a single stream that includes the requested content plus additional content spliced into the stream, such as one or more ads or commercials. The stream also includes metadata embedded into the stream that corresponds to the additional content.

The single content stream is processed to playback the media content and the additional media content (block 306). For example, the media player application can process the streaming data as it is downloaded and load processed data for display via a display device.

Responsive to encountering the metadata during the processing of the single content stream, the metadata is parsed to identify the additional media content and ascertain when the additional media content begins playback (block 308). In one or more implementations, the media player may lack the capability to identify the additional media content or the subject matter of the additional media content when the additional media content is streamed via the same content stream as that of the requested media content.

In this example, however, metadata that was embedded into the content stream is encountered by the media player application and parsed. The metadata can be embedded in particular locations within the content stream such that when the media player, during processing of the streaming data, encounters the spliced-in alternate content, the media player can also encounter the metadata. This metadata can include information associated with the additional media content to allow the media player application to identify the additional media content for purposes of performing one or more operations, examples of which are described above.

The metadata is used to track the additional media content (block 310). For example, the media player application can use the information associated with the additional media content to track or otherwise identify the additional media content.

Example System and Device

FIG. 4 illustrates an example system generally at 400 that includes an example computing device 402 that is representative of one or more computing systems and/or devices that may implement the various techniques described herein. This is illustrated through inclusion of application manager module 132, which may be configured to manage applications, such as a media player application, on the computing device 402. The computing device 402 may be, for example, a server of a service provider, a device associated with a client (e.g., a client device), an on-chip system, and/or any other suitable computing device or computing system.

The example computing device 402 as illustrated includes a processing system 404, one or more computer-readable media 406, and one or more I/O interface 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware element 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 406 is illustrated as including memory/storage 412. The memory/storage 412 represents memory/storage capacity associated with one or more computer-readable media. The memory/storage component 412 may include volatile media (such as random access memory (RAM)) and/or nonvolatile media (such as read only memory (ROM), Flash memory, optical disks, magnetic disks, and so forth). The memory/storage component 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 410 and computer-readable media 406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of a module that is executable by the computing device 402 as software may be achieved at least partially in hardware, e.g., through use of computer-readable storage media and/or hardware elements 410 of the processing system 404. The instructions and/or functions may be executable/operable by one or more articles of manufacture (for example, one or more computing devices 402 and/or processing systems 404) to implement techniques, modules, and examples described herein.

The techniques described herein may be supported by various configurations of the computing device 402 and are not limited to the specific examples of the techniques described herein. This functionality may also be implemented all or in part through use of a distributed system, such as over a “cloud” 414 via a platform 416 as described below.

Cloud 414 includes and/or is representative of a platform 416 for resources 418. Platform 416 abstracts underlying functionality of hardware (e.g., servers) and software resources of the cloud 414. Resources 418 may include applications and/or data that can be utilized while computer processing is executed on servers that are remote from the computing device 402. Resources 418 can also include services 420 provided over the Internet and/or through a subscriber network, such as a cellular or Wi-Fi network.

Platform 416 may abstract resources and functions to connect computing device 402 with other computing devices. Platform 416 may also serve to abstract scaling of resources to provide a corresponding level of scale to encountered demand for resources 418 that are implemented via platform 416. Accordingly, in an interconnected device embodiment, implementation of functionality described herein may be distributed throughout system 400. For example, the functionality may be implemented in part on computing device 402 as well as via platform 416 that abstracts the functionality of cloud 414.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method, comprising:
obtaining media content responsive to a request, the media content being included in a content stream that also includes alternate content that is spliced into the content stream;
injecting metadata into the content stream at runtime in association with a starting point of the alternate content, the metadata configured to enable a media player to identify the alternate content and a location of the alternate content within the content stream; and
transmitting the content stream as a single stream to the media player for playback of both the media content and the alternate content.

2. A computer-implemented method as recited in claim 1, further comprising:
determining whether the metadata is pre-packaged with the alternate content; and
performing said injecting of the metadata responsive to a determination that the metadata is not pre-packaged with the alternate content.

3. A computer-implemented method as recited in claim 1, wherein the metadata is generated at runtime.

4. A computer-implemented method as recited in claim 1, wherein the alternate content is obtained from an ad server.

5. A computer-implemented method as recited in claim 1, wherein the alternate content comprises one or more advertisements.

6. A computer-implemented method as recited in claim 1, wherein the metadata includes a link to additional content associated with the alternate content.

7. A system, comprising:
one or more processors; and
a memory having instructions that are executable by the one or more processors to implement a media content service, the media content service configured to at least:
receive a request for content to be delivered via a single stream of content;
identify advertisement locations corresponding to one or more advertisements that are included in the single stream of content; and
embed metadata into the single stream of content at runtime based on the request, the metadata being associated with the one or more advertisements to enable a client device to identify the one or more advertisements and ascertain when the one or more advertisements begin playback within the single stream of content based on the advertisement locations.

8. A system as recited in claim 7, wherein the media content service is further configured to generate the metadata for the one or more advertisements in response to the request being received.

9. A system as recited in claim 8, wherein the metadata is embedded into the single stream of content in response to a determination that the one or more advertisements do not include associated pre-packaged metadata.

10. A system as recited in claim 7, wherein the metadata includes a link to additional content that is associated with the one or more advertisements.

11. A system as recited in claim 7, wherein the metadata is configured to identify a beginning location of the one or more advertisements within the single stream of content.

12. A system as recited in claim 7, wherein the metadata includes a link to a merchant site that sells products or services associated with the one or more advertisements.

13. A system as recited in claim 7, wherein metadata embedded into the single stream is configured to enable the client device to track the one or more advertisements.

14. Computer-readable storage media comprising instructions that are executable by a computing device to implement a video player, the video player configured to perform operations comprising:
transmitting a request for media content to a media source;
receiving a single content stream comprising the media content, additional media content that was spliced in to the single content stream, and metadata associated with the additional media content;
processing the single content stream to playback the media content and the additional media content;
responsive to encountering the metadata during said processing of the single content stream, parsing the metadata to identify the additional media content and ascertain when the additional media content begins playback; and
using the metadata to track the additional media content.

15. Computer-readable storage media as recited in claim 14, wherein the video player comprises a single player and is configured to playback both the media content and the additional media content in the single content stream without utilizing a second video player to playback the additional media content.

16. Computer-readable storage media as recited in claim 14, wherein the operations further comprise playing back additional media content in the single content stream without blocking playback of the media content.

17. Computer-readable storage media as recited in claim 14, wherein the metadata was embedded into the single content stream at runtime in response to the request for the media content.

18. Computer-readable storage media as recited in claim 14, wherein the metadata is used to determine when playback of the additional media content has ended.

19. Computer-readable storage media as recited in claim 14, wherein the additional media content comprises one or more advertisements.

20. Computer-readable storage media as recited in claim 14, wherein the metadata includes a link to a merchant site that sells products or services associated with the additional media content.
